(19) United States
(12) Patent Application Publication
(10) Pub. No.: US 2005/0131669 A1
(43) Pub. Date: Jun. 16, 2005

(54) Method for simulating the system performance of an on chip system

(76) Inventor: Carsten Mielenz, Landsberg (DE)

Correspondence Address: SLATER & MATSIL LLP, 17950 PRESTON ROAD, SUITE 1000, DALLAS, TX, 75252, US

(21) Appl. No.: 10/987,198

(22) Filed: Nov. 12, 2004

(30) Foreign Application Priority Data
Nov. 14, 2003 (DE) 103 53 580.2

(51) Int. Cl. G06F 9/45

(52) U.S. Cl. 703/22

(57) ABSTRACT

A method for simulating the system performance of an on-chip system is disclosed. The on-chip system includes a hardware architecture, which includes a processor core, a bus, memory and peripheral units, and a software architecture, which includes device drivers, a piece of firmware, an operating system and application software, in which a hardware model and a software performance model are created and the system performance is simulated on the hardware model using the software performance model.

This application claims priority to German Patent Application 103 53 580.2, which was filed Nov. 14, 2003, and is incorporated herein by reference.

### TECHNICAL FIELD

The invention relates to a method for simulating the system performance of an on-chip system, in which a hardware model and a software performance model are created and the system performance is simulated on the hardware model using the software performance model.

### BACKGROUND

To achieve various objects in the field of communication for automation technology or for data processing, complex computer systems implemented in “systems-on-chip” are being used to an ever-greater extent. A system-on-chip comprises a hardware architecture and a software architecture. The hardware architecture usually includes a plurality of processor cores, buses, memories and peripheral devices and the software architecture usually includes device drivers, a piece of firmware, an operating system and application software. Both architectures are reflected in an arrangement of circuit elements on a semiconductor chip.

The implementation on the semiconductor chip is effected using a specification which comprises a software-end description of the individual method steps for patterning the semiconductor chip. A specification of this type is achieved by virtue of an experienced person skilled in the art using his estimation of the required software performance to assemble from a stock of various specification modules the specification which, according to his experience, best fulfills the user-specific objective which is to be achieved.

It becomes clear from this that momentous decisions that determine the later hardware and software architecture are actually made at a very early time within the design process. The design process for these systems includes basic architecture decisions for the design, such as decisions about the split of the hardware and software, the dimensions given to the storage variables or the communication topology. By way of example, large portions of the necessary algorithm in “wireless base band” applications are implemented in a piece of software, which runs on processor cores. For this reason, it is of great importance to detect the performance that the software requires in order to create a system performance model.

It is current practice to create software performance models from existing program codes in the software, for example from existing C or assembler codes. Consequently, a software performance model is not available apart from, for an at least initial version, of a piece of software. If the design process should now involve a system performance simulation being effected using a software performance model, then there is not yet any software available at this stage for creating such a model.

Hence, although some software tasks can be simulated on a hardware model, as is known from the prior art, a simulation of this type does not cope with the complexity of a system-on-chip for a number of reasons. First, the software performance model cannot be created until after the software has been implemented, that is to say at a time at which the decisions made in the specification phase have already taken effect in further steps. If this simulation establishes that one of the decisions has been made incorrectly, the process comprising specification and implementation needs to be performed again, which means not inconsiderable involvement. Secondly, it can be used to simulate only small software portions, but not the full scope of the software architecture. Finally, initial errors that cannot be ascertained by virtue of this incomplete simulation are not detected until very late in the design phase or even not until the finished product. In such a case, the resultant loss of time and production is considerable.

### SUMMARY OF THE INVENTION

For this reason, the invention provides a way of allowing a system-on-chip to be simulated at the architecture level before a specification is created.

In one aspect, this can be achieved by virtue of the software performance model being created prior to implementation of software corresponding to the software architecture into the on-chip system as a first estimated software architecture in an executable software architecture specification which represents the software architecture in the form of system demands and system states. Similarly, the hardware model of a first estimated hardware architecture is created as an executable hardware architecture specification. The software architecture specification is then executed on an arithmetic and logic unit by accessing the hardware architecture specification. Normally, a monitor program runs in parallel, which can be used to ascertain parameters which are to be evaluated, such as bus utilization level, memory use, memory access operations etc., which are then used to evaluate the simulation.

The preferred embodiment of this invention solves problems of presenting a software performance model by taking into account the desired application software in the phase when the on-chip system is designed, in which there is not yet any initial implementation of the software from which it would be possible to obtain a software performance model. As a result, it becomes possible to make decisions about the software and hardware architecture on time and hence to avoid unnecessary involvement in the case of incorrect decisions.

In one refinement of the invention, the creation of a software architecture specification is facilitated by providing that the software architecture specification comprise elements in a language which can be read by humans. Such a language will be called APDL (=Application Profile Definition Language) below.

APDL contains the following symbols:

| | |
|---|---|
| = | is composed of |
| + | and |
| ( ) | optional (may be present or absent) |
| { } | iteration |
| * * | comment |
| @ | identifier |
| \| | separation of alternative selection in [ ] |

APDL contains the following common data types:

| | |
|---|---|
| -dec_digit == | [ 0-9 ] |
| -hex_digit == | [ 0-9 \| A-F \| a-f ] |
| -letter = | [A-Z \| a-z ] |
| -character = | [ letter \| number \| ‘_‘ ] |
| -string = | { character } |
| -hex_number = | ‘Ox‘ + { hex_digit } |
| -float_number = | { dec_digit + ‘.‘ + dec_digit } |
| -int_number = | { dec_digit } |
| -int_range = | int_number + ‘−‘ + int_number |
| -function_name = | ‘&‘ + string |
| -time_unit = | ‘#‘ + [ int_number \| float_number \| |
| | hex_number \| function_name ] |
| -base_address = | hex_number |
| -size = | hex_number |
| -mem_reference = | ‘$‘ + string |

In a further refinement of the invention, provision is made for the software architecture specification to contain the estimated software architecture in the form of data for the utilization levels of the processors, for the utilization level and actuation of peripheral units and/or for the utilization level as a result of internal process cycles.

It thus becomes obvious that creation of the software architecture specification requires no knowledge about the processor instruction set or similar internal processor knowledge. This makes the inventive method embodiments easy to handle.

A further refinement of the invention is characterized in that the software architecture specification contains at least one application profile definition, which for its part contains a definition of the memory areas and a multiplicity of software tasks.

In one development of the invention, provision is made for the application profile definition to contain definitions for controlling real-time operation in the form of time-control and priority definitions.

In APDL, the following syntax is set for the application profile definition (APD):

$$\begin{matrix}apd = @ APD\_BEGIN + \\ ( memory\_section ) + \\ ( \{ riot\_state \} ) + \\ \{ task \} + \\ @ APD\_END\end{matrix}$$

In this case, “memory section” defines the memory areas and “rtos state” defines the real-time conditions.

In APDL, the memory area is defined as follows:

$$\begin{matrix}memory\_section = @ MEMORY\_MAP \_BEGIN + \\ \{ mem\_reference + ’ = ’ + base\_address + ‘ , ‘ + size ) + \\ @ MEMORY\_MAP \_END\end{matrix}$$

The memory addresses are stipulated in APDL using the definition:

$$\begin{matrix}address = ‘ @ ‘ + \\ [ hex\_number \vert mem\_reference \vert function\_name ] + \\ ( ‘ [ ‘ + [ int\_number \vert function\_name ] + ‘ ] ‘ )\end{matrix}$$

Finally, the definitions for real-time processing are specified as follows in APDL:

$$\begin{matrix}rtos\_section = @ RTOS\_STATE \_BEGIN + string + \\ ( @ PREEMPTION ‘ = ‘ [ ‘ Y ‘ \vert ‘ y ‘ \vert ‘ N ‘ \vert ‘ n ‘ ] ) + \\ ( @ PRIO\_LEVELS ‘ = ‘ int\_number ) + \\ ( \{ scheduling\_subsection \} ) + \\ ( STATESWITCH\_RUNMODE + ‘ = ‘ + \\ int\_number ) + \\ ( semaphore\_subsection ) + \\ @ RTOS\_STATE \_END\end{matrix}$$

scheduling_subsection=@SCHEDULING

$$\begin{matrix}scheduling\_subsection = @ SCHEDULING + \\ ( @ LEVEL + [ int\_range \vert int\_number ] ) + \\ ‘ = ‘ [ @ FIFO \vert @ ROUND\_ROBIN + \\ time\_unit ]\end{matrix}$$

In one development, it is expedient that each task has the same task structure, comprising a basic data part, an activation instruction part and a performance instruction part.

The syntax in APDL for this is

$$\begin{matrix}task = @ TASK\_BEGIN + \\ basic\_section + \\ activation\_section + \\ performance\_section + \\ @ TASK\_END\end{matrix}$$

In this context, the basic data part is defined by

$$\begin{matrix}basic\_section = @ ID + ‘ = ‘ + string + \\ ( @ SIZE + ‘ = ‘ + hex\_number ) + \\ ( @ BASE + ‘ = ‘ + address ) + \\ ( @ RUN\_MODE + ‘ = ‘ + int\_number )\end{matrix}$$

The activation instruction part is defined by

$$\begin{matrix}activation\_section = \{ trigger\_condition \} + \\ @ STORE\_TIME + ‘ = ‘ + time\_unit + \\ @ RESTORE\_TIME + ‘ = ‘ + time\_unit\end{matrix}$$

In this, the following further definitions are made:

trigger_condition = [

| | @INTERRUPT + ‘,‘ + int_number |
|---|---|
| \| | @CYCLIC + ‘,‘ + time_unit |
| \| | @INIT |
| \| | @BACK + ‘,‘ + float_number ] |

The performance instruction part of a task is specified in APDL by performance_section=
{[performance_element|conditional|loop]}

In this case, performance instruction segments are specified by

performance_element = [

| | @BUSY + time_unit |
|---|---|
| \| | PUT_DATA + address |
| \| | GET_DATA + address |
| \| | @SLEEP + time_unit |
| \| | @SET_PRIORITY + ‘=‘ + int_number |
| \| | @SET_LOCK + ‘=‘ + [ ‘Y‘ \| ‘y‘ \| ‘N‘ \| ‘n‘ ] |
| \| | function_name \| EXEC string + ( time_unit ) ] |
| \| | @SET_RTOS_STATE + ‘=‘ + string |

The conditions for the occurrence of a performance instruction element are specified by

$$\begin{matrix}conditional = @ IF + ‘ ( ‘ + function\_name + ‘ ) ‘ + \\ \{ performance\_element \} + \\ ( @ ELSE + \{ performance\_element \} ) + \\ @ ENDIF\end{matrix}$$

Finally, embodiments of the inventive method can be used for purposefully altering the system architecture by virtue of the simulation being used to ascertain performance parameters for the estimated on-chip system, and the performance parameters being altered by repeating the simulation with a software architecture specification for a second estimated software architecture and with a hardware architecture specification for a second estimated hardware architecture.

The invention uses early availability of a software performance model to permit the system architecture to be simulated in the design phase without this requiring knowledge of details of a (later) software implementation.

The executable software architecture specification allows the software performance model to be simulated immediately in APDL in connection with the system performance model.

When the preferred embodiment of the inventive method is carried out, no particular knowledge of the processor programming is required, since APDL is independent of the processor instruction set. It thus becomes possible even for non-experts to create the software performance model.

The implementation of the application software and the configuration of the system architecture are normally done in different teams. A software performance model in APDL represents a means of communication between the individual design teams, i.e., between software designers, who estimate the profile of a future piece of application software in APDL, and system designers, who use the APDL specification for the purpose of system performance analysis.

When the application software has been implemented, the APDL software model can be improved in order to introduce more details into the performance model. In this way, the functionality of the initial system architecture can also, since more detailed software performance information is available.

### BRIEF DESCRIPTION OF THE DRAWINGS

The invention will be explained in more detail below with reference to an exemplary embodiment. In the associated drawings,

FIG. 1 shows a basic illustration of a method based on the invention;

FIG. 2 shows a block diagram of a UMTS DSP subunit;

FIG. 3 shows the illustration of three tasks for real-time processing; and

FIG. 4 shows the illustration of the real-time processing of the three tasks shown in FIG. 3 with processor use in a real-time operating system.

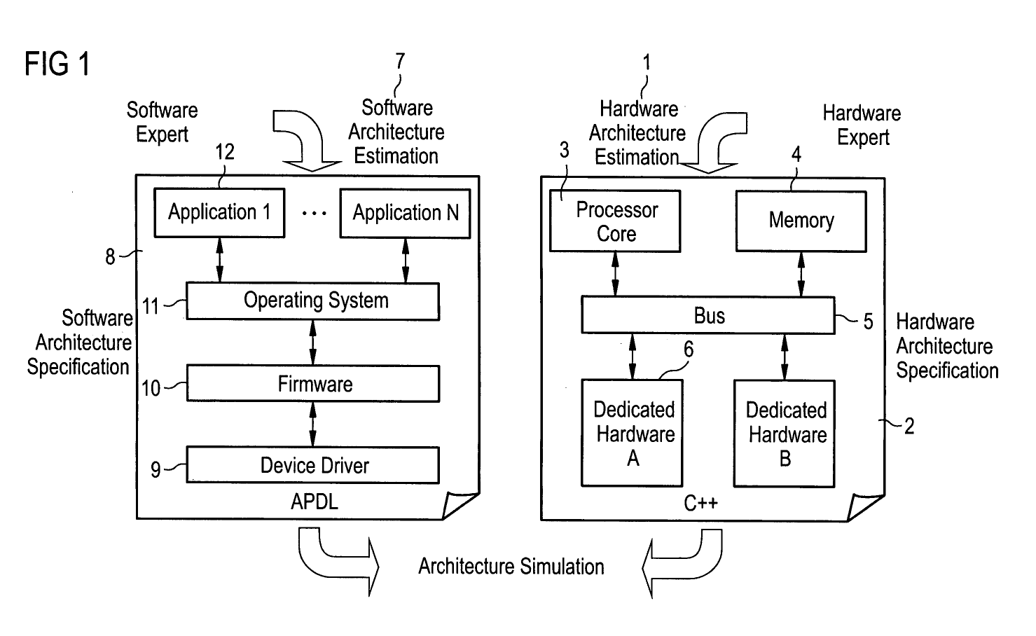

The following list of reference symbols can be used in conjunction with the figures
1 Hardware architecture estimation
2 Hardware architecture specification
3 Processor core
4 Memory
5 Bus
6 Hardware component
7 Software architecture estimation
8 Software architecture specification
9 Device driver
10 Firmware
11 Operating system
12 Application software
13 UMTS DSP subunit
14 Data store
15 Direct memory access
16 Rake unit
17 CRC unit
18 Bus system
19 Task A
20 Task B
21 Task C

### DETAILED DESCRIPTION OF ILLUSTRATIVE EMBODIMENTS

A hardware expert uses his experience to estimate the hardware architecture, to the extent that it supposedly comes as close as possible to achieving the objective, namely the use of a piece of application software. This hardware architecture estimation 1 is then converted using the programming language C++ to a hardware model specification 2 with a processor core 3, a memory 4, a bus 5 and special hardware components 6.

In a similar manner, a software expert performs a software architecture estimation. Using a second programming language, the programming language APDL which the invention has created specifically for creating software models, the software architecture estimation 7 is converted to a software architecture specification 8 which contains program parts for device drivers 9, a piece of firmware 10, an operating system 11 and various applications 12.

The hardware architecture specification 2 and the software architecture specification 8 are compiled on a respective dedicated compiler on a computer to produce a piece of executable code. This means that it is possible to allow the software architecture estimation 7 to “run” on the hardware architecture estimation 1, i.e., to simulate it on the basis thereof. In this context, a monitor (not shown in more detail) in the form of a monitor program observes the behavior of the models, which allows conclusions to be drawn about the rest of the behavior.

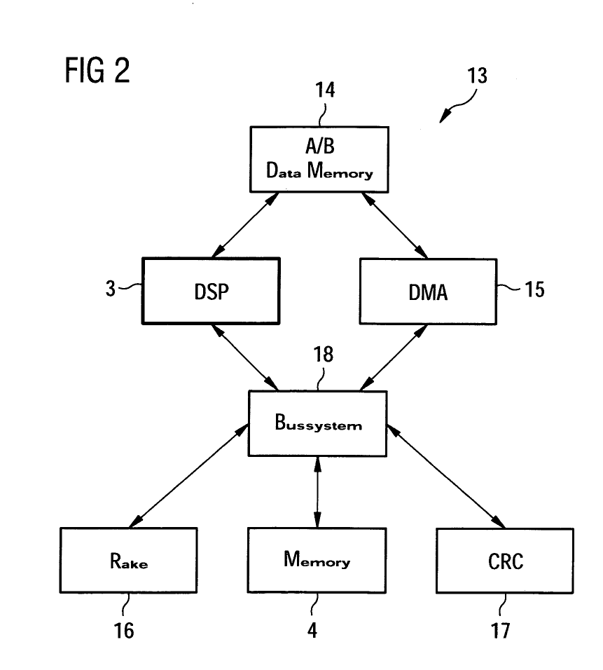

FIG. 2 shows the block diagram of a UMTS (Universal Mobile Telecommunications System) DSP (digital signal processor) subunit 13, as would be adopted by a hardware expert in order to be able to execute application programs for implementing UMTS in various devices. This design represents the hardware architecture estimation 1.

This hardware architecture estimation 1 contains a processor core 3 and a data store 14, which is connected directly to the processor core 3 and is managed by means of direct memory access 15.

A rake unit 16, a memory 4 and a CRC (cyclic redundancy check) unit 17 are connected to one another via a bus system 18 and to the processor core 3 and to the direct memory access 15.

For this hardware architecture estimation 1, a C++ hardware architecture specification 2 is created.

The text below shows a section from a list of tasks which have been taken as extracts from the inventive software architecture estimation 7:
get slot
Initiation of a transfer from the direct memory access 15 to the data store 14 following an interrupt by the rake unit 16
process frame
Data extraction, second deinterleaving, physical channel combination
first deintervleaving a
Initiation of an interleaved transfer via the direct memory access 15 from the data store 14 to the memory 4
first deinterleaving b
Initiation of an interleaved transfer via the direct memory access 15 from the memory 4 to the data store 14
trch demux
Demultiplex transport channel and eliminate p bit

The inventive programming language APDL will now be used to illustrate the tasks cited as extracts from the software architecture estimation 7 in the software architecture specification 8 as follows:

| | | |
|---|---|---|
| TASK_BEGIN | | |
| | ID = get_slot | |
| | TRIGGER = INTERRUPT, $rake_slot | //activated by interrupt from the |
| | | rake unit 16 |
| | STORE_TIME = #5 | |
| | RESTORE_TIME = #5 | |
| | BUSY #10 | //processor core 3 is busy for 10 |
| | | cycles |
| | &generate_dma_slot_transfer | //generate a DMA request message |
| | | (function call) |
| | PUT_DATA $dma_address | //send request to direct memory |
| | | access 15 |
| TASK_END | | |
| TASK_BEGIN | | |
| | ID = process_frame | |
| | TRIGGER = INTERRUPT, $dma_slot_complete | //activated by interrupt from the |
| | | direct memory access 15 |
| | STORE_TIME = #5 | |
| | RESTORE_TIME = #5 | |
| | BUSY #5 | //processor core 3 is busy for 5 |
| | | cycles |
| | IF &frame_complete | |
| | GET_DATA $frame[&frame_index] | |
| | BUSY #100 | |
| | PUT_DATA $tti_address[&tti_index] | |
| | EXEC first_deinterleaving_a | //call deinter-leaving task |
| | END_IF | |
| TASK_END | | |
| TASK_BEGIN | | |
| | ID = first_deinterleaving_a | |
| | STORE_TIME = #5 | |
| | RESTORE_TIME = #5 | |
| | BUSY #10 | //processor core 3 is busy for 10 |
| | | cycles |
| | &generate_dma_interleave_a | //generate a DMA request message |
| | | (function call) |
| | PUT_DATA $dma_address | //send a request to the direct |
| | | memory access 15 |
| TASK_END | | |
| TASK_BEGIN | | |
| | ID = first_deinterleaving_b | |
| | TRIGGER = INTERRUPT, $dma_interleave_a | //activated when direct memory |
| | | access 15 is finished |
| | STORE_TIME = #5 | |
| | RESTORE_TIME = #5 | |
| | BUSY #10 | //processor core 3 is busy for 10 |
| | | cycles |
| | &generate_dma_interleave_b | //generate a DMA request message |
| | | (function call) |
| | PUT_DATA $dma_address | //send a request to the direct |
| | | memory access 15 |
| TASK_END | | |
| TASK_BEGIN | | |
| | ID = trch_demux | |
| | TRIGGER = INTERRUPT, $dma_interleave_b | //activated upon interrupt from the |
| | | direct memory access 15 |
| | STORE_TIME = #5 | |
| | RESTORE_TIME = #5 | |
| | BUSY #5 | //processor core 3 is busy for 5 |
| | | cycles |
| | GET_DATA $deint_tti[&deint_tti_index] | |
| | BUSY #100 | |
| | PUT_DATA $ | |
| | END_IF | |
| TASK_END | | |

This task list is then compiled on a computer using the rest of the software architecture specification 8, which is of similar design, and is executed together with the compiled hardware architecture specification 2.

From this, it is possible to make the following statements about the concurrent monitoring:
regarding processor core 3:
   use
   time for task services which are influenced by the interrupts
      (this allows a list of interrupt priorities to be stipulated.)
regarding bus 5:
   use
      this allows stipulations regarding bus frequency and the need for memory swapping.)
regarding memory 4:
   bandwidth and use
      (this allows stipulations regarding memory mapping and regarding the memory bandwidth—dual or single port.)

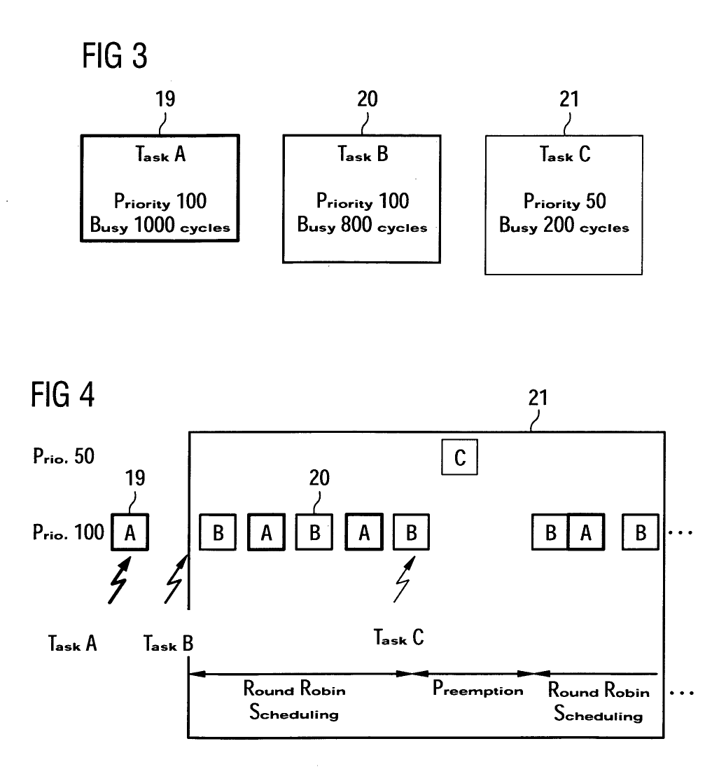

The text below is intended to illustrate the creation of part of the software architecture specification 8 for simulating the flow of a real-time operating system (RTOS) for three tasks. The three tasks are shown in FIG. 3.

In this case, task A 19 has a priority of 100 and uses 1000 cycles for its execution. Task B 20 has the same priority but uses only 800 cycles. The same priority means that both tasks 19 and 20 need to be executed with equal access authorization. In line with the illustration in FIG. 4, this is done using round robin scheduling, where the tasks are always executed alternately with equal access authorization. Task C 21 with a necessary cycle time of 200 has a higher priority of 50, which is why task C 21 interrupts the execution of tasks 19 and 20 and is executed. Next, the round robin scheduling for the two tasks 19 and 20 is continued. In this way, tasks 19 to 21 are executed on the basis of the RTOS. An execution option of this type may become part of the software architecture and therefore needs to be included in the software architecture estimation 7.

APDL can be used to implement this estimation in the software architecture specification very quickly and easily:
PREEMPTION=Y//the tasks can be interrupted
PRIO_LEVELS=256//number of priority levels
SCHEDULING=ROUND_ROBIN 100//stipulation of level-dependent scheduling

This stipulates that task C 21 may interrupt the tasks of lower priority and that round robin scheduling is otherwise carried out for a priority of 100.

As can be seen from this example, it is possible to prescribe this task execution and the structure of the tasks themselves without knowledge of the exact program flow of an application program. It is thus possible to use the software architecture estimation 7 with the aid of the conversion to a software architecture specification 8 to test whether the hardware architecture estimation 1 is able to meet the demands or whether modifications to both estimations need to be performed in order to meet the demands of the application software. This can be done before software implementation has taken place on the hardware configuration, that is to say at an early time, which makes it possible to avoid unnecessary complexity to a considerable extent.

1. A method for simulating system performance of an on-chip system that comprises a hardware architecture that includes a processor core, a bus, memory and peripheral units, and a software architecture that includes device drivers, a piece of firmware, an operating system and application software, the method comprising:
creating a software performance model prior to implementation of software corresponding to the software architecture into the on-chip system as a first estimated software architecture in an executable software architecture specification that represents the software architecture in the form of system commands and system states; and
creating a hardware model of a first estimated hardware architecture as an executable hardware architecture specification; and
executing the software architecture specification on an arithmetic and logic unit by accessing the hardware architecture specification.

2. The method as claimed in claim 1, wherein the software architecture specification comprises elements in a language which can be read by humans.

3. The method as claimed in claim 1, wherein the software architecture specification contains the estimated software architecture in the form of data for the utilization levels of the processors, for the utilization level of peripheral units and/or for the utilization level as a result of internal process cycles.

4. The method as claimed in claim 4, wherein the software architecture specification contains the estimated software architecture in the form of data for the utilization levels of the processors.

5. The method as claimed in claim 4, wherein the software architecture specification contains the estimated software architecture in the form of data for the utilization level of peripheral units.

6. The method as claimed in claim 4, wherein the software architecture specification contains the estimated software architecture in the form of data for the utilization level as a result of internal process cycles.

7. The method as claimed in claim 1, wherein the software architecture specification contains at least one application profile definition which for its part contains a definition of the memory areas and a multiplicity of software tasks.

8. The method as claimed in claim 7, wherein the application profile definition contains definitions for controlling the real-time operation in the form of time-control and priority definitions.

9. The method as claimed in claim 8, wherein each task has the same task structure, which comprises a basic data part, an activation instruction part and a performance instruction part.

10. The method as claimed in claim 7, wherein each task has the same task structure, which comprises a basic data part, an activation instruction part and a performance instruction part.

11. The method as claimed in claim 1, wherein the simulation is used to ascertain performance parameters for the estimated on-chip system, and wherein the performance parameters are altered by repeating the simulation with a software architecture specification for a second estimated software architecture and with a hardware architecture specification for a second estimated hardware architecture.

12. The method as claimed in claim 1, wherein the on-chip system comprises a digital signal processor.
